(19) United States
(12) Patent Application Publication
(10) Pub. No.: US 2015/0106264 A1
(43) Pub. Date: Apr. 16, 2015

(54) CONTROLLING DEBIT CARD TRANSACTIONS

(71) Applicant: Bank of America Corporation, Charlotte, NC (US)

(72) Inventor: Tyler R. JOHNSON, Tega Cay, SC (US)

(73) Assignee: Bank of America Corporation, Charlotte, NC (US)

(21) Appl. No.: 14/052,115

(22) Filed: Oct. 11, 2013

(51) Int. Cl. G06Q 20/26; G06Q 20/40

(52) U.S. Cl. CPC G06Q 20/26; G06Q 20/40
USPC 705/44

(57) ABSTRACT

Methods and systems for controlling debit card transactions are presented. In some embodiments, a computer system may receive authentication information associated with a debit card. Subsequently, the computer system may determine, based on boundary information, whether the transaction terminal device is authorized to perform one or more transactions on at least one financial account linked to the debit card. Based on determining that the transaction terminal device is authorized to perform one or more transactions on the at least one financial account, the computer system may allow the transaction terminal device to perform at least one transaction on the at least one financial account. Alternatively, based on determining that the transaction terminal device is not authorized to perform one or more transactions on the at least one financial account, the computer system may prevent the transaction terminal device from performing any transactions on the at least one financial account.

### BACKGROUND

Aspects of the disclosure relate to computer hardware and software. In particular, one or more aspects of the disclosure generally relate to computer hardware and software for controlling debit card transactions.

Debit cards are becoming increasingly popular among customers of financial institutions. As more and more people use debit cards, it is becoming increasingly important to ensure that such cards, as well as the features that they provide, are safe, secure, and reliable. Ensuring the safety, security, and reliability of debit cards not only protects individual cardholders from having their account information being used improperly, but it also protects the financial institution issuing the cards from absorbing financial losses and being exposed to other harms that might result from such account information being used improperly.

### SUMMARY

Aspects of the disclosure relate to various systems and techniques that provide effective, efficient, scalable, and convenient ways of controlling debit card transactions. In particular, some aspects of the disclosure provide ways of allowing individual cardholders to define personal boundaries and/or other restrictions on usage of their debit cards that can increase the safety, security, and reliability of their debit cards and the features and functionalities that these cards enable.

One issue associated with debit card use is “skimming,” which refers to situations in which a person improperly captures a card account number and a personal identification number (PIN) while a debit card is being legitimately used by an authorized user of the card at an automated teller machine, point-of-sale terminal, or other transaction terminal device. Once the person has this information, he or she can typically sell it on the black market, thereby exposing the cardholder and the financial institution that issued the debit card to illegitimate transactions and/or other unauthorized use of the card.

Some current anti-skimming solutions that have been deployed aim to prevent the harvesting of card account numbers, PIN numbers, and other information. But if such information is taken, and a debit card is successfully cloned and used without authorization, illegitimate transactions made with the cloned debit card may be approved and/or otherwise allowed to proceed. By implementing one or more aspects of the disclosure, this issue and/or other issues may be mitigated and/or avoided.

In particular, a given cardholder may often use his or her debit card within a certain region for the vast majority of his or her transactions, and perhaps may use his or her debit card at the same specific automated teller machines, point-of-sale terminals, and/or other transaction terminal devices for these transactions. Aspects of the disclosure provide ways of allowing a cardholder to define particular locations, and in some instances, particular devices, where his or her debit card can be used (e.g., to the exclusion of other locations and/or devices), thereby providing greater control to the individual cardholder while simultaneously increasing safety and security of the debit card for both the cardholder and the financial institution that issued the debit card.

For example, some embodiments discussed in greater detail below provide techniques for restricting where a debit card can be used based on boundary information, which may include restricting authorized use of the debit card to particular devices (e.g., specific automated teller machines, specific point-of-sale terminals, and/or one or more other specific devices) and/or restricting authorized use of the debit card to particular regions (e.g., specific neighborhoods, cities, regional areas, states, countries, and/or the like). In some embodiments, the restrictions imposed on authorized use of a debit card may have one or more temporal components, such that certain devices and/or regions may be selectively authorized and/or disabled during certain times (e.g., when a cardholder may be traveling away from his or her home or away from another usual card usage area for the cardholder). In addition, some aspects of the disclosure provide ways for a cardholder to dynamically enable a specific automated teller machine, point-of-sale terminal, or other device that has not been previously authorized but which the cardholder currently wishes to use.

By leveraging various aspects of these techniques and/or the other features and functionalities discussed in greater detail below, greater control over debit cards, as well as enhanced account security, can be provided both to cardholders and to the financial institutions that may issue these cards. Moreover, because debit cards are linked to funds that are the actual property of the cardholders (e.g., unlike credit cards, which enable transactions that represent loans made by a financial institution to a cardholder), aspects of the disclosure provide cardholder-driven security measures for debit cards that might not otherwise be implementable in view of this facet of the nature of debit cards. In particular, without the knowledge, consent, and/or explicit instructions of a cardholder, there might only be limited circumstances, if there is any at all, in which a financial institution may prevent usage of a debit card where a valid card account number and matching PIN number have otherwise been supplied in an attempt to perform a transaction.

Thus, in some embodiments discussed below, a computer system (which may, e.g., be a server computer system that is operated and/or controlled by a financial institution) may receive authentication information associated with a debit card. Subsequently, the computer system may determine, based on boundary information, whether the transaction terminal device is authorized to perform one or more transactions on at least one financial account linked to the debit card. Based on determining that the transaction terminal device is authorized to perform one or more transactions on the at least one financial account, the computer system may allow the transaction terminal device to perform at least one transaction on the at least one financial account. Alternatively, based on determining that the transaction terminal device is not authorized to perform one or more transactions on the at least one financial account, the computer system may prevent the transaction terminal device from performing one or more transactions on the at least one financial account.

In some instances, the transaction terminal device may be an automated teller machine. In other instances, the transaction terminal device may be a point-of-sale terminal. In some instances, the authentication information may include a card account number and a personal identification number (PIN) associated with the debit card.

In one or more arrangements, the boundary information may specify at least one boundary defined by an authorized user of the debit card. In some instances, the at least one boundary may be defined by the authorized user of the debit card via an online interface. In other instances, the at least one boundary may be defined by the authorized user of the debit card via an ATM interface. In some instances, the boundary information may identify one or more specific ATMs at which the debit card is authorized for use. In other instances, the boundary information may define a geographic region in which the debit card is authorized for use. In still other instances, the boundary information may define at least one temporal limit in which the debit card is authorized for use.

In at least one arrangement, preventing the transaction terminal device from performing one or more transactions on the at least one financial account may include causing a user of the transaction terminal device to be prompted to dynamically enable the transaction terminal device to perform one or more transactions on the at least one financial account.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of an automated teller machine according to one or more aspects of the disclosure;

FIG. 3 illustrates a flowchart that depicts a method of controlling debit card transactions according to one or more aspects of the disclosure;

FIG. 4 illustrates a flowchart that depicts another method of controlling debit card transactions according to one or more aspects of the disclosure;

FIG. 5 illustrates an example of a user interface that may be displayed in allowing an authorized user of a debit card to define one or more boundaries according to one or more aspects of the disclosure; and

FIG. 6 illustrates an example of a user interface that may be displayed in prompting a user to dynamically enable a device to perform one or more transactions according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

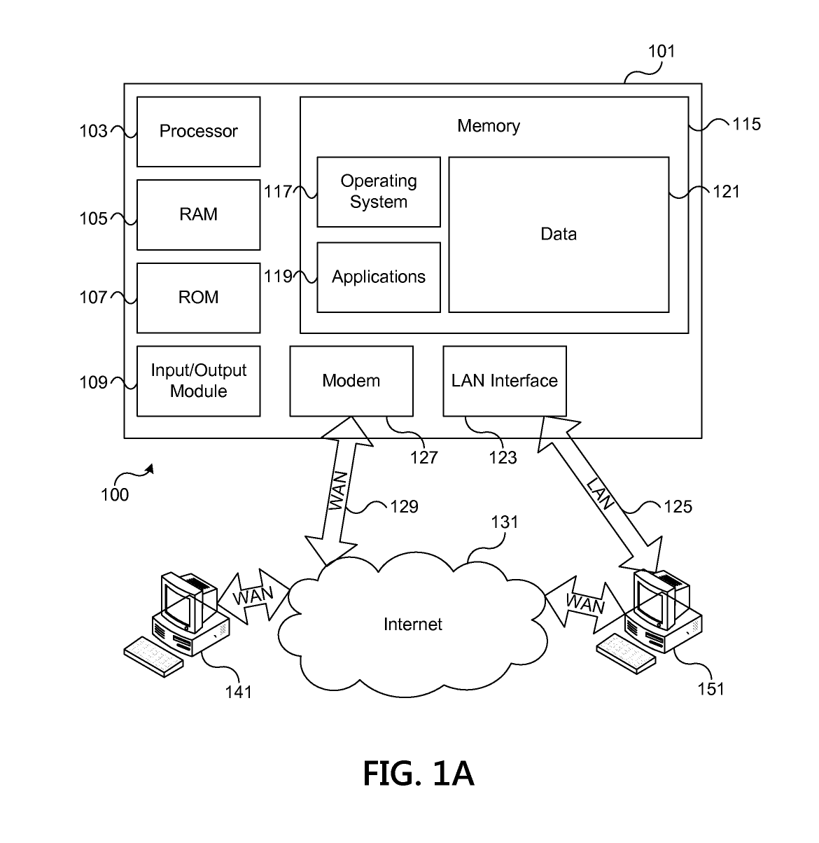

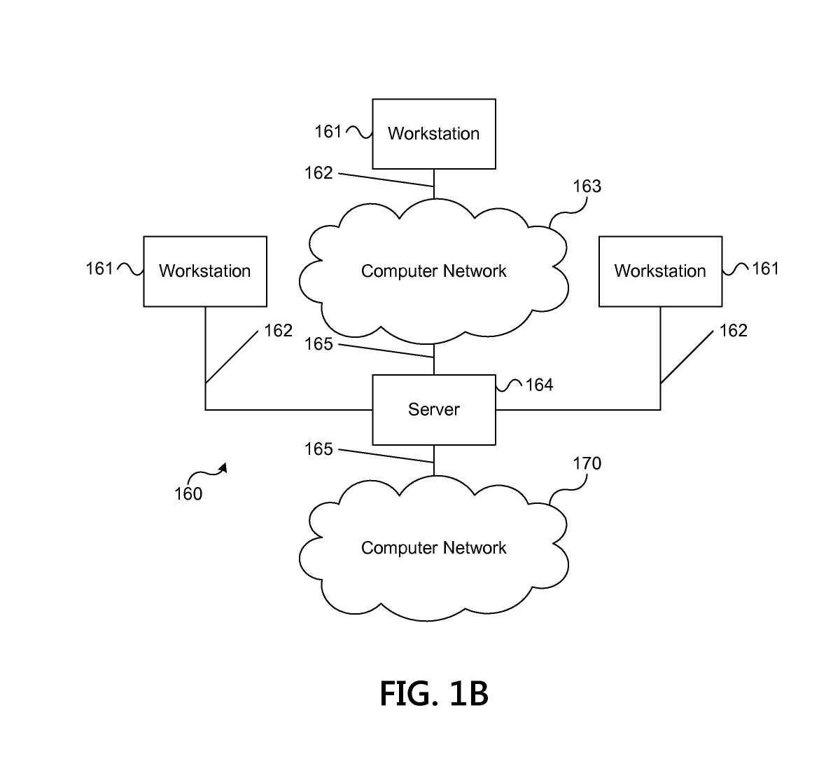

As noted above, certain embodiments are discussed herein that relate to controlling debit card transactions. Before discussing these concepts in greater detail, however, an example of a computing device that can be used in implementing various aspects of the disclosure, as well as an example of an operating environment in which various embodiments can be implemented, will first be described with respect to FIGS. 1A and 1B. In addition, an example of an automated teller machine that may be used in implementing some aspects of the disclosure will be described with respect to FIG. 2.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

FIG. 2 illustrates an example of an automated teller machine (ATM) 200 according to one or more aspects of the disclosure. As discussed herein, an “automated teller machine,” such as ATM 200, may include and/or incorporate one or more computing devices and/or one or more other components and/or devices that may enable the automated teller machine to receive user input (e.g., from customers of a financial institution), connect to and/or communicate with other devices and/or servers (which may, e.g., include other devices and/or servers that are operated and/or controlled by a financial institution), and/or process transactions (which may, e.g., be requested by users of the automated teller machine and may, for instance, include currency withdrawal transactions, current deposit transactions, check deposit transactions, balance inquiry transactions, and/or other types of transactions). In some instances, the term “automated teller machine,” as used herein, thus may include conventional automated teller machines, as well as other types of similar systems, including automated teller assistants, video teller assistants, and/or other types of currency handling devices.

As seen in FIG. 2, ATM 200 may include various subsystems that may exchange digital information and/or analog electrical signals with each other via wired and/or wireless connections to facilitate operation of the ATM 200 and/or execution of the various functions that the ATM 200 may provide. In one or more arrangements, ATM 200 may include a control subsystem 205, a communication subsystem 210, an input/output (I/O) subsystem 215, a document receiving subsystem 220, and a currency dispensing subsystem 225. While these subsystems are discussed herein as examples of the subsystems that may be included in ATM 200 in some embodiments, the ATM 200 may, in other embodiments, include additional and/or alternative subsystems than those discussed with respect to FIG. 2. For instance, one or more of the example subsystems may be combined and/or replaced by other subsystems that may enable ATM 200 to provide similar, additional, and/or alternative functionalities.

In some embodiments, control subsystem 205 may be configured to monitor, manage, command, and/or otherwise control one or more of the other subsystems included in ATM 200, as well as the overall operations of and/or functionalities provided by the ATM 200. For example, control subsystem 205 may include one or more processors 205a and memory 205b. The one or more processors 205a may, for instance, be configured to receive and/or process information and/or signals received from other subsystems, and may be further configured to send commands, other information, and/or various signals to the other subsystems included in ATM 200. In addition, memory 205b may be configured to store computer-readable instructions and/or other information that may cause the one or more processors 205a to execute various programs and/or that may be otherwise used by the one or more processors 205a.

In some embodiments, communication subsystem 210 may be configured to send, receive, and/or otherwise facilitate communications between ATM 200 and one or more servers and/or other computing devices. For example, communication subsystem 210 may include one or more network interfaces 210a and/or one or more local radiofrequency (RF) interfaces 210b. The one or more network interfaces 210a may, for instance, include one or more wired and/or wireless communications interfaces, such as one or more Ethernet interfaces, one or more IEEE 802.11a/b/g/n interfaces, one or more cellular interfaces (e.g., CDMA interfaces, GSM interfaces, and/or the like), and/or one or more other interfaces. The one or more network interfaces 210a may, for example, enable the ATM 200 to communicate with one or more servers and/or other devices via various networks, which may include local area networks (LANs), wireless local area networks (WLANs), cellular networks, and/or other networks. In addition, the one or more local RF interfaces 210b may, for instance, include one or more short-range wireless communication interfaces, such as one or more near field communications (NFC) interfaces, one or more Bluetooth interfaces, and/or one or more other interfaces. The one or more local RF interfaces 210b may, for instance, enable the ATM 200 to communicate with a local device, such as a mobile computing device used by a user of the ATM 200, that may be within close range of (and/or otherwise within a predetermined distance of) the ATM 200.

In some embodiments, input/output (I/O) subsystem 215 may be configured to receive one or more types of input (e.g., from a user of the ATM 200) and/or provide one or more types of output (e.g., to the user of the ATM 200). For example, I/O subsystem 215 may include a display 215a, a keypad 215b, a mouse 215c, a card reader 215d, an optical scanner 215e, a printer 215f, and/or one or more other I/O devices 215g that each may be configured to receive and/or provide various types of input and/or output. The display 215a may, for instance, be configured to display and/or otherwise provide graphical and/or video output to a user of the ATM 200. In some instances, display 215a may include a touchscreen that may, for instance, be configured to receive input from a user of the ATM 200 via one or more touch-sensitive surfaces. In addition, keypad 215b may, for instance, include one or more buttons that are configured to allow a user of the ATM 200 to provide character input, and mouse 215c may be configured to allow the user to move a cursor and select items included in a user interface. Card reader 215d may, for instance, include one or more receptacles, magnetic stripe readers, chip readers, and/or the like, and may be configured to physically receive and electronically obtain information from a payment card, such as a debit card or credit card. Optical scanner 215e may, for instance, include one or more cameras and may be configured to capture an image and obtain information from items included in the image, such as one or more barcodes and/or quick response (QR) codes. Printer 215f may, for instance, be configured to print one or more receipts and/or other documents that may provide physical output to a user of the ATM 200. Furthermore, one or more other input and/or output devices 215g may receive and/or provide additional and/or alternative types of input and/or output to a user of the ATM 200.

In some embodiments, document receiving subsystem 220 may be configured to receive various types of documents (e.g., from a user of the ATM 200 who may, for instance, be depositing funds and/or otherwise submitting one or more documents for processing by a financial institution operating the ATM 200). For example, document receiving subsystem 220 may include one or more currency receiving devices 220a and/or one or more document receiving devices 220b. The one or more currency receiving devices 220a may, for instance, include one or more slots, rollers, scanners, cartridges, and/or other components that may be configured to physically receive, process, and/or store various types of currency (e.g., coins, bills, and/or other types of currency). In addition, the one or more document receiving devices 220b may, for instance, include one or more slots, rollers, scanners, cartridges, and/or other components that may be configured to physically receive, process, and/or store various types of financial documents (e.g., checks).

In some embodiments, currency receiving subsystem 225 may be configured to dispense various types of currency and/or other items (e.g., to a user of the ATM 200 who may, for instance, be withdrawing funds and/or otherwise obtaining documents and/or other items from the ATM 200). For example, currency dispensing subsystem 225 may include one or more bill dispensing devices 225a, one or more coin dispensing devices 225b, and/or one or more other dispensing devices 225c. The one or more bill dispensing devices 225a may, for instance, include one or more slots, rollers, scanners, cartridges, and/or other components that may be configured to physically dispense one or more bills (e.g., to a user of the ATM 200). The one or more coin dispensing devices 225b may, for instance, include one or more slots, rollers, scanners, cartridges, and/or other components that may be configured to physically dispense one or more coins (e.g., to a user of the ATM 200). Additionally, the one or more other dispensing devices 225c may, for instance, include one or more slots, rollers, scanners, cartridges, and/or other components that may be configured to dispense one or more other items to a user of the ATM 200.

As noted above, while the ATM 200 and the various subsystems and/or other devices discussed above illustrate one or more example arrangements of an automated teller machine in some embodiments, one or more other subsystems and/or devices may be included in an automated teller machine in addition to and/or instead of those discussed above in other embodiments.

Having described an example of a computing device that can be used in implementing various aspects of the disclosure and an operating environment in which various aspects of the disclosure can be implemented, as well as an example of an automated teller machine that may be used in implementing some aspects of the disclosure, several embodiments will now be discussed in greater detail.

As introduced above, some aspects of the disclosure generally relate to controlling debit card transactions. In the discussion below, various examples illustrating how such transactions may be controlled in accordance with one or more embodiments will be provided.

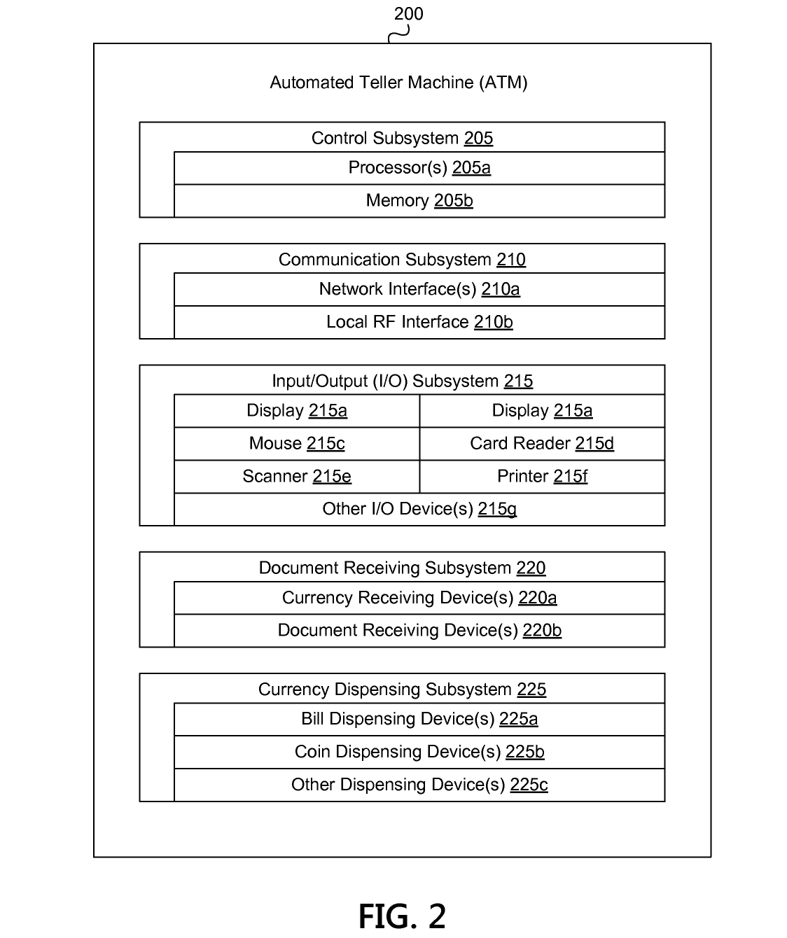

FIG. 3 illustrates a flowchart that depicts a method of controlling debit card transactions according to one or more aspects of the disclosure. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as a server computer system that is owned, operated, and/or controlled by a financial institution (which may, e.g., maintain the computer system in a back office or data center to process debit card transactions), and such a computer system may include one or more computing devices that include and/or implement one or more aspects of computing device 101. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which authentication information may be received from a transaction terminal device. For example, in step 305, a server computer system may receive authentication information associated with a debit card from a transaction terminal device. The transaction terminal device may, for instance, be sending the authentication information to the server computer system after a person has presented the debit card at the transaction terminal device and attempted to initiate and/or complete a transaction using the debit card.

In some instances, the transaction terminal device may be an automated teller machine, such as ATM 200, and an individual may, for example, be presenting the debit card at the automated teller machine to authenticate and/or request a withdrawal transaction. In other instances, the transaction terminal device may be a point-of-sale terminal, and an individual may, for example, be presented the debit card at the point-of-sale terminal to authenticate and/or complete a payment transaction. In one or more arrangements, the authentication information (which may, e.g., be received by the server computer system in step 305) may include a card account number and a personal identification number (PIN) associated with the debit card. In the preceding examples, the information that is received from the automated teller machine or the point-of-sale terminal thus may include a card account number associated with the debit card that has been presented and a PIN that has been entered and/or otherwise submitted by an individual who is attempting to use the debit card to initiate and/or complete a transaction.

In step 310, it may be determined, based on boundary information, whether the transaction terminal device is authorized to perform one or more transactions on at least one financial account linked to the debit card. For example, in step 310, the server computer system may determine, based on boundary information, whether the transaction terminal device (e.g., from which the authentication information was received in step 305) is authorized to perform one or more transactions on at least one financial account linked to the debit card. In one or more arrangements, the boundary information may, for instance, specifically identify authorized device(s) with which the particular debit card may be used, authorized region(s) in which the particular debit card may be used, and/or authorized time(s) during which the particular debit card may be used. Different boundary information may be defined for different debit cards (which may, e.g., allow for individual cardholders to create and implement controls that are specifically tailored to their individual needs and preferences).

In some embodiments, the boundary information may specify at least one boundary defined by an authorized user of the debit card. For example, the boundary information may, in some instances, specifically identify authorized device(s) with which the particular debit card may be used, authorized region(s) in which the particular debit card may be used, and/or authorized time(s) during which the particular debit card may be used, and any and/or all of these boundaries may have been previously defined by an authorized user of the debit card (who may, e.g., be the primary accountholder for one or more accounts that are linked to the debit card, an otherwise authorized accountholder for such accounts, and/or an otherwise authorized user of the debit card). As discussed below, an authorized user of the debit card may, for instance, have defined any and/or all of these boundaries using various types of user interfaces, and the authorized user may be able to modify these boundaries in different ways.

If it is determined, in step 310, that the transaction terminal device is authorized to perform one or more transactions on the at least one financial account, then in step 315, the transaction terminal device may be allowed to perform at least one transaction on the at least one financial account. For example, in step 315, based on determining that the transaction terminal device is authorized to perform one or more transactions on the at least one financial account, the server computer system may allow the transaction terminal device to perform at least one transaction on the at least one financial account. In allowing the transaction terminal device to perform the at least one transaction on the at least one financial account, the server computer system may, for instance, send information to and/or otherwise exchange information with the transaction terminal device indicating that the debit card presented at the transaction terminal device (and/or the individual who presented the debit card) is authorized to transact on one or more accounts linked to the debit card (which may, e.g., include one or more checking accounts, one or more savings accounts, and/or one or more other accounts). Additionally or alternatively, the information that may be sent and/or otherwise provided to the transaction terminal device by the server computer system may include additional information about the account(s) linked to the debit card (e.g., information about the type(s) of account(s) linked to the debit card, such as whether the account(s) are checking account(s), savings account(s), and/or other type(s) of account(s); information about the balance(s) of account(s) linked to the debit card; and/or other information about the account(s) linked to the debit card) and/or information about the authorized user of the debit card (e.g., information about the authorized user's name, information about the authorized user's billing address, and/or other information about the authorized user of the debit card).

If it is determined, in step 310, that the transaction terminal device is not authorized to perform one or more transactions on the at least one financial account, then in step 320, the transaction terminal device may be prevented from performing one or more transactions on the at least one financial account. For example, in step 320, based on determining that the transaction terminal device is not authorized to perform one or more transactions on the at least one financial account, the server computer system may prevent the transaction terminal device from performing one or more transactions on the at least one financial account. In preventing the transaction terminal device from performing one or more transactions on the at least one financial account, the server computer system may, for instance, send information to and/or otherwise exchange information with the transaction terminal device indicating that the debit card presented at the transaction terminal device (and/or the individual who presented the debit card) is not authorized to transact on one or more accounts linked to the debit card. Additionally or alternatively, the information that may be sent and/or otherwise provided to the transaction terminal device by the server computer system may include additional information that may be configured to prevent the transaction terminal device from allowing the user of the debit card to request and/or initiate a transaction using the debit card (e.g., by declining the debit card, flagging the debit card as being unauthorized for use, and/or otherwise preventing use of the debit card). In some instances, in preventing the transaction terminal device from performing one or more transactions on the at least one financial account, the server computer system may additionally or alternatively prompt an authorized user of the debit card for authorization to proceed (and/or otherwise notify an authorized user of the debit card), as discussed below.

In some embodiments in which the boundary information specifies at least one boundary defined by an authorized user of the debit card, the at least one boundary may be defined by the authorized user of the debit card via an online interface. For example, the boundary information may, in some instances, include at least one boundary that has been defined by the authorized user of the debit card using an online interface. Such an online interface may, for instance, be provided via a website (which may, e.g., be accessible to the user via a web browser) and/or via a mobile application or “app” (which may, e.g., be accessible to the user via a mobile computing device that is capable of and/or configured to execute such an application). Such an online interface may, for instance, be generated by and/or provided by the server computer system (which may, e.g., be performing the method illustrated in FIG. 3) in some instances, and in other instances, the online interface may be generated by and/or provided by one or more other systems that may, for instance, be configured to provide the user's selections regarding boundaries to the server computer system. Additionally or alternatively, the online interface may be configured to allow an authorized user of the debit card to initially define one or more boundaries with respect to the debit card, and/or the online interface may be configured to allow an authorized user of the debit card to modify and/or delete one or more boundaries with respect to the debit card. In some instances, such an online interface may be interacted with and/or operated by a customer service representative of the financial institution who may, e.g., interact with an authorized user of the debit card over the phone or via other means and who may, e.g., set and/or assist the user in setting one or more boundaries for their debit card.

In some embodiments in which the boundary information specifies at least one boundary defined by an authorized user of the debit card, the at least one boundary may be defined by the authorized user of the debit card via an ATM interface. For example, the boundary information may, in some instances, include at least one boundary that has been defined by the authorized user of the debit card using an interface presented at and/or displayed by an automated teller machine. In some instances, such an interface might only be presented at and/or displayed by an automated teller machine that the authorized user of the debit card has historically used (which may, e.g., mean that the authorized user of the debit card has used the ATM to complete at least a predetermined number of transactions within a predetermined amount of time of the present), as this may ensure security in instances where the authorized user of the debit card wishes to create, modify, and/or delete boundaries for his or her debit card. In some instances, this restriction may be imposed by the server computer system, which may, for example, be configured to provide such an ATM with information about the authorized user's existing boundary settings and/or may be further configured to exchange information with the ATM to facilitate to changes to the user's boundary settings.

In some embodiments, the boundary information may identify one or more specific ATMs at which the debit card is authorized for use. In these instances, the boundary information may, for example, thus limit usage of the debit card only to one or more specific automated teller machines, such that the debit card cannot be used at any other automated teller machines, point-of-sale terminals, or any other transaction terminal devices. In instances in which this boundary information is defined by an authorized user of the debit card, the cardholder may interact with a mobile banking interface, an ATM interface, or some other security preferences interface, and such an interface may, for example, include a list indicating the ATMs that have been previously used by the cardholder (e.g., the list may indicate to the cardholder that “These are the last five ATMs that you have used more than three times in the last year.”) In addition, such an interface may, for example, include a prompt asking the cardholder whether he or she wishes to authorize only those ATMs for use, to the exclusion of other ATMs and devices (e.g., the prompt may ask the cardholder “Would you like to only enable these five ATMs for utilization? Your debit card will not be able to be used at other ATMs and devices unless you adjust your settings or dynamically enable your card for temporary use.”). In some instances, the one or more specific ATMs at which the debit card is authorized for use may be owned and/or operated by the same financial institution that issued the debit card to the cardholder, while in other instances, one or more of the specific ATMs that are authorized may be owned and/or operated by a different financial institution than the financial institution that issued the debit card to the cardholder.

In some embodiments, the boundary information may define a geographic region in which the debit card is authorized for use. In these instances, the boundary information may, for example, thus limit usage of the debit card only to automated teller machines, point-of-sale terminals, and other transaction terminal devices that are located with one or more specific geographic regions, such that the debit card cannot be used at devices in any other geographic regions. For example, an authorized user of the debit card may define one or more geographic regions in which the debit card is authorized for use, such as “Charlotte Metropolitan Area” or “North Carolina and South Carolina,” and this boundary definition may cause the server computer system to only allow the debit card to be used when presented at a transaction terminal device in one of the specified regions, and may further cause the server computer system to prevent the debit card from being used when presented at a transaction terminal device that is not within one of the specified regions.

In some embodiments, the boundary information may define at least one temporal limit in which the debit card is authorized for use. In these instances, the boundary information may, for example, thus limit usage of the debit card only to certain times and/or in certain locations, such that the debit card cannot be used at other times. Such a temporal limit may be defined in association with a geographic limit or independently of a geographic limit. For example, an authorized user of the debit card may define a temporal limit in which the debit card is authorized for use in association with a geographic limit, such as “California for the next two weeks,” and this boundary definition may allow the debit card to be used at transaction terminal devices in the specified region during the specified time. As another example, an authorized user of the debit card may define a temporal limit in which the debit card is authorized for use independently of a geographic limit, such as “Everywhere for the next week,” and this boundary definition may allow the debit card to be used at any transaction terminal device during the specified time. In some instances, after the temporal limit expires, the debit card may continue to be used only at authorized devices and/or in authorized regions that have been previously and/or permanently authorized (which may, e.g., simply mean that such devices and/or regions have been authorized by one or more boundaries that have been defined without a temporal limit, as in several of the examples discussed above).

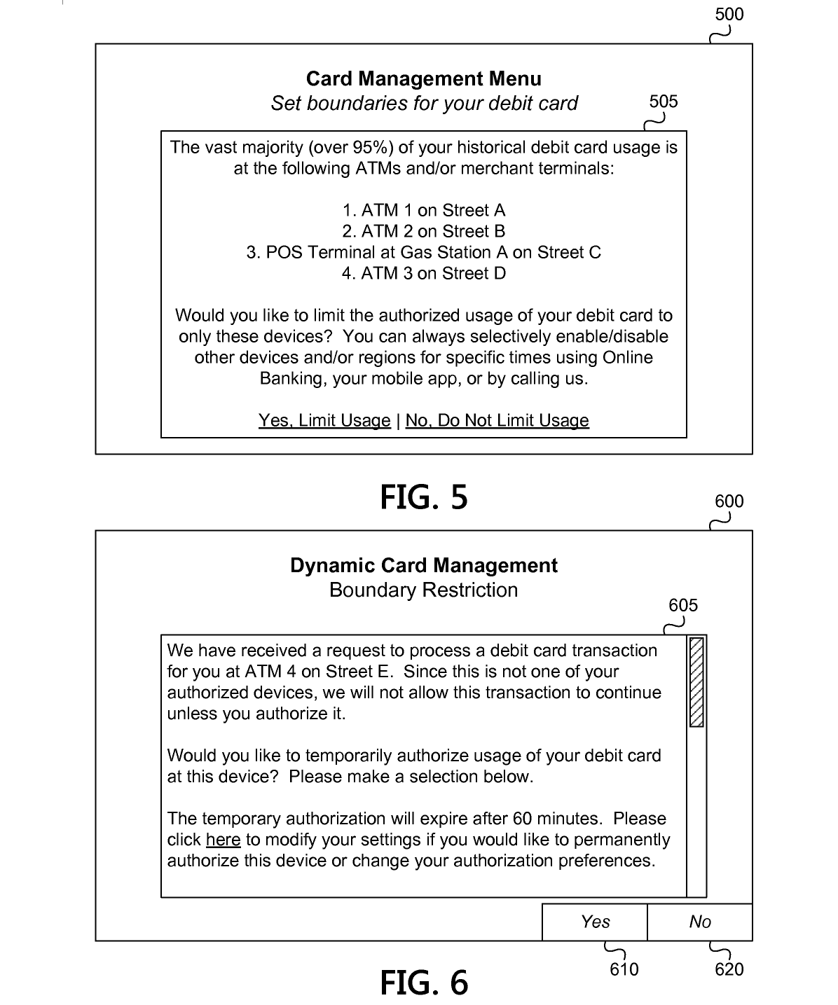

In some embodiments, preventing the transaction terminal device from performing one or more transactions on the at least one financial account may include causing a user of the transaction terminal device to be prompted to dynamically enable the transaction terminal device to perform one or more transactions on the at least one financial account. For example, in preventing the transaction terminal device from performing one or more transactions, the server computer system may, in some instances, cause a user of the transaction terminal device to be prompted to dynamically enable the transaction terminal device to perform a requested transaction. In some instances, in causing a user of the transaction terminal device to be prompted, the server computer system may, for instance, cause a prompt and/or other notification to be sent to an authorized user of the debit card and/or a computing device linked to and/or associated with the authorized user of the debit card. For example, in causing the user to be prompted, the server computer system may cause a push notification or other message to be sent to the authorized user of the debit card (which may, e.g., be displayed by a mobile application on the authorized user's mobile device). An example of such a push notification is discussed below with respect to FIG. 6. Additionally or alternatively, the server computer system may cause an automated telephone call to be initiated and/or may cause a text message to be sent that may prompt and/or otherwise allow the authorized user of the debit card to provide responsive input to dynamically enable the particular transaction terminal device for use with the debit card (e.g., by speaking with a customer service representative via the telephone call, by answering a prompt included in the text message and/or otherwise responding to the text message, and/or in other ways). Additionally or alternatively, the server computer system may cause one or more security questions to be presented at and/or displayed by the transaction terminal device itself (which may, e.g., allow the cardholder to answer such question(s) and/or provide other additional input to authenticate and subsequently cause the transaction terminal device to be dynamically enabled, as such a security question answer and/or other additional input might not be known by a person who has illegitimately acquired the card account number and PIN via skimming).

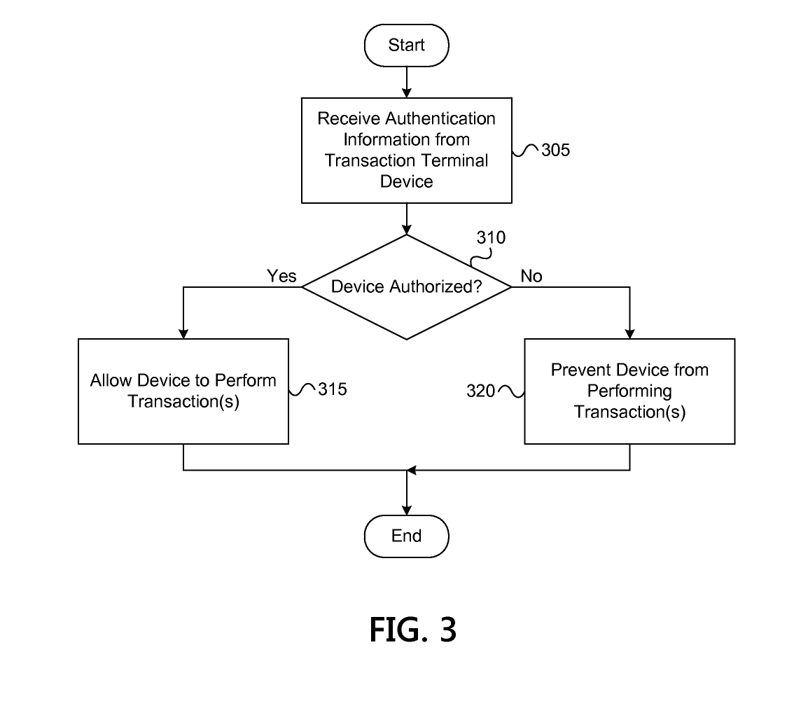

FIG. 4 illustrates a flowchart that depicts another method of controlling debit card transactions according to one or more aspects of the disclosure. In some embodiments, the example method illustrated in FIG. 4 may be performed by an automated teller machine, which may include and/or implement one or more aspects of ATM 200. In additional and/or alternative embodiments, the example method illustrated in FIG. 4 may be performed by a computing device, which may include and/or implement one or more aspects of computing device 101. In other embodiments, the example method illustrated in FIG. 4 may be implemented in and/or may otherwise be embodied in computer-readable instructions that may be stored in a computer-readable medium, such as a memory.

As seen in FIG. 4, the method may be initiated in step 405, in which a debit card may be received by an automated teller machine, such as ATM 200. In step 410, authentication information associated with the debit card may be received by the automated teller machine (e.g., the user of the ATM may enter a PIN and/or other authentication information). In step 415, the automated teller machine may determine whether the received authentication information is valid (e.g., by comparing the authentication information to one or more locally stored records and/or by communicating with one or more remote server computer systems to validate the authentication information).

If it is determined that the authentication information is not valid, then in step 420, an error message may be displayed by the automated teller machine. In some instances, the user of the automated teller machine may be prompted to reattempt entry of the authentication information. Alternatively, if it is determined that the authentication information is valid, then in step 425, the automated teller machine may determine, based on boundary information, whether the automated teller machine is authorized to perform one or more transactions on at least one financial account linked to the debit card. In determining, based on boundary information, whether the automated teller machine is authorized to perform one or more transactions, the automated teller machine may, for instance, send information to and/or otherwise exchange information with one or more remote server computer systems, such as the server computer system discussed above. For example, in determining whether the automated teller machine is authorized to perform one or more transactions, the automated teller machine may send information about the debit card received in step 405, as well as the authentication information received in step 410 and identification information for the automated teller machine itself (which may, e.g., allow the server computer system to identify and/or locate the automated teller machine), to the server computer system. As discussed above, the server computer system may be configured to evaluate whether the automated teller machine is authorized to conduct transactions with respect to the particular debit card, and after the server computer system evaluates the information provided the automated teller machine, the automated teller machine may receive, from the server computer system, information indicating whether the automated teller machine is authorized to perform one or more transactions with respect to at least one financial account linked to the debit card.

If it is determined that the automated teller machine is not authorized to perform one or more transactions on at least one financial account linked to the debit card, then in step 430, the automated teller machine may display a notification indicating that the debit card is not authorized for use at the ATM. Additionally or alternatively, an authorized user of the debit card may receive a notification and/or otherwise be prompted to dynamically enable the automated teller machine (e.g., as discussed above). Alternatively, if it is determine that the ATM is authorized to perform one or more transactions on the at least one financial account, then in step 435, the automated teller machine may display a transaction menu that includes a user-selectable list of possible transactions. For example, the automated teller machine may display a transaction menu that allows the user to select to withdraw funds from one or more accounts linked to the debit card and/or perform other transactions with respect to the linked account(s).

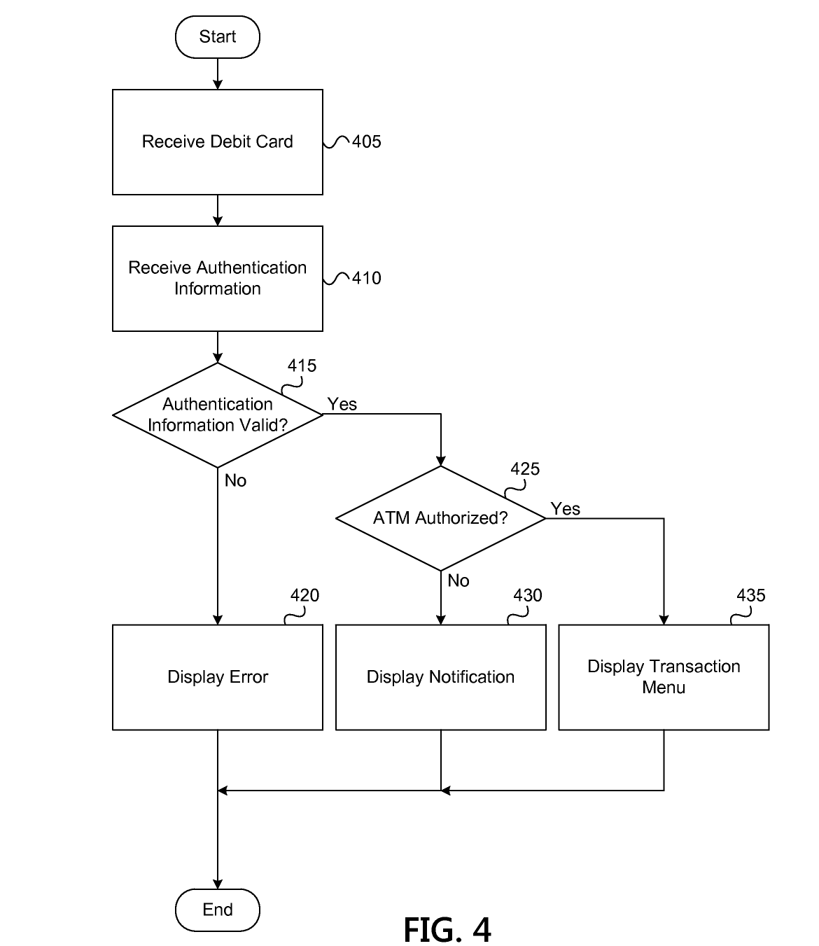

Having described several examples of the processing that may be performed in controlling debit card transactions in some embodiments, several example user interfaces that might be displayed and/or otherwise provided by a computing device, such as a computing device implementing one or more aspects of computing device 101 and/or an automated teller machine implementing one or more aspects of ATM 200, in performing such processing and/or in otherwise implementing various aspects of the disclosure will now be discussed with respect to FIGS. 5 and 6.

FIG. 5 illustrates an example of a user interface that may be displayed in allowing an authorized user of a debit card to define one or more boundaries according to one or more aspects of the disclosure. As seen in FIG. 5, in some instances, a computing device implementing one or more aspects of the disclosure (e.g., computing device 101, ATM 200, and/or one or more other devices) may display and/or otherwise provide a user interface 500 that includes information about historical debit card usage, as well as one or more options for defining one or more boundaries for a particular debit card. Such a user interface may, for example, enable a cardholder to define, modify, and/or delete one or more boundaries for his or her debit card, in accordance with various aspects of the disclosure.

For instance, user interface 500 may include an information box 505 in which information about historical debit card usage for a particular debit card, as well as one or more options for specifying boundary information for the debit card. For example, by selecting “Yes, Limit Usage,” a cardholder interacting with user interface 500 may be able to limit authorized usage of his or her debit card to only the automated teller machines, point-of-sale terminals, and/or other transaction terminal devices included in the listing included in information box 505. In addition, user interface 500 may, in some instances, be presented to the cardholder via an online banking interface (e.g., as a web page and/or as a menu in a mobile banking application being executed on the cardholder's mobile computing device), and in other instances, may be presented to the cardholder on an automated teller machine that the cardholder may be using and/or otherwise interacting with.

FIG. 6 illustrates an example of a user interface that may be displayed in prompting a user to dynamically enable a device to perform one or more transactions according to one or more aspects of the disclosure. As seen in FIG. 6, in some instances, a computing device implementing one or more aspects of the disclosure (e.g., computing device 101, ATM 200, and/or one or more other devices) may display and/or otherwise provide a user interface 600 that includes information prompting an authorized user of a debit card to select whether to dynamically authorize a particular automated teller machine, point-of-sale terminal, or other transaction terminal device for use with the debit card. Such a user interface may, for example, enable a cardholder to dynamically enable his or her debit card for use with such a device, in accordance with various aspects of the disclosure.

For instance, user interface 600 may include an information box 605 in which information prompting a user to dynamically enable a particular transaction terminal device may be displayed, as well as a yes button 610 and a no button 620 that may allow the user to respond to the prompt. For example, by selecting yes button 610, a cardholder interacting with user interface 600 may be able to dynamically authorize his or her debit card to be used at a particular transaction terminal device (e.g., as in the examples discussed above). Alternatively, by selecting no button 620, the cardholder interacting with user interface 600 may be able to prevent his or her debit card from being used at such a transaction terminal device.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A method, comprising:
receiving, at a server computer system, from a transaction terminal device, authentication information associated with a debit card;
determining, by the server computer system, based on boundary information, whether the transaction terminal device is authorized to perform one or more transactions on at least one financial account linked to the debit card;
based on determining that the transaction terminal device is authorized to perform one or more transactions on the at least one financial account, allowing, by the server computer system, the transaction terminal device to perform at least one transaction on the at least one financial account; and
based on determining that the transaction terminal device is not authorized to perform one or more transactions on the at least one financial account, preventing, by the server computer system, the transaction terminal device from performing one or more transactions on the at least one financial account.

2. The method of claim 1, wherein the transaction terminal device is an automated teller machine (ATM).

3. The method of claim 1, wherein the transaction terminal device is a point-of-sale (POS) terminal.

4. The method of claim 1, wherein the authentication information includes a card account number and a personal identification number (PIN) associated with the debit card.

5. The method of claim 1, wherein the boundary information specifies at least one boundary defined by an authorized user of the debit card.

6. The method of claim 5, wherein the at least one boundary is defined by the authorized user of the debit card via an online interface.

7. The method of claim 5, wherein the at least one boundary is defined by the authorized user of the debit card via an ATM interface.

8. The method of claim 5, wherein the boundary information identifies one or more specific ATMs at which the debit card is authorized for use.

9. The method of claim 5, wherein the boundary information defines a geographic region in which the debit card is authorized for use.

10. The method of claim 5, wherein the boundary information defines at least one temporal limit in which the debit card is authorized for use.

11. The method of claim 1, wherein preventing the transaction terminal device from performing one or more transactions on the at least one financial account includes:
causing a user of the transaction terminal device to be prompted to dynamically enable the transaction terminal device to perform one or more transactions on the at least one financial account.

12. A computer system, comprising:
at least one processor; and
memory storing computer-readable instructions that, when executed by the at least one processor, cause the computer system to:
receive, from a transaction terminal device, authentication information associated with a debit card;
determine, based on boundary information, whether the transaction terminal device is authorized to perform one or more transactions on at least one financial account linked to the debit card;
based on determining that the transaction terminal device is authorized to perform one or more transactions on the at least one financial account, allow the transaction terminal device to perform at least one transaction on the at least one financial account; and
based on determining that the transaction terminal device is not authorized to perform one or more transactions on the at least one financial account, prevent the transaction terminal device from performing one or more transactions on the at least one financial account.

13. The computer system of claim 12, wherein the transaction terminal device is an automated teller machine (ATM).

14. The computer system of claim 12, wherein the transaction terminal device is a point-of-sale (POS) terminal.

15. The computer system of claim 12, wherein the authentication information includes a card account number and a personal identification number (PIN) associated with the debit card.

16. The computer system of claim 12, wherein the boundary information specifies at least one boundary defined by an authorized user of the debit card.

17. The computer system of claim 16, wherein the at least one boundary is defined by the authorized user of the debit card via an online interface.

18. The computer system of claim 16, wherein the at least one boundary is defined by the authorized user of the debit card via an ATM interface.

19. The computer system of claim 16, wherein the boundary information identifies one or more specific ATMs at which the debit card is authorized for use.

20. The computer system of claim 16, wherein the boundary information defines a geographic region in which the debit card is authorized for use.

21. The computer system of claim 16, wherein the boundary information defines at least one temporal limit in which the debit card is authorized for use.

22. The computer system of claim 12, wherein preventing the transaction terminal device from performing one or more transactions on the at least one financial account includes:
causing a user of the transaction terminal device to be prompted to dynamically enable the transaction terminal device to perform one or more transactions on the at least one financial account.

23. A method, comprising:
receiving, by an automated teller machine (ATM), a debit card;
receiving, by the ATM, authentication information associated with the debit card;
determining, by the ATM, whether the authentication information is valid;
based on determining that the authentication information is valid, determining, by the ATM, based on boundary information, whether the ATM is authorized to perform one or more transactions on at least one financial account linked to the debit card;
based on determining that the ATM is authorized to perform one or more transactions on the at least one financial account, displaying, by the ATM, a transaction menu that includes a user-selectable list of possible transactions; and
based on determining that the ATM is not authorized to perform one or more transactions on the at least one financial account, displaying, by the ATM, a notification indicating that the debit card is not authorized for use at the ATM.
